(19) United States
(12) Patent Application Publication
(10) Pub. No.: US 2024/0125946 A1
(43) Pub. Date: Apr. 18, 2024

(54) Method for the GNSS-Based Localization of a Vehicle with 5G Signals

(71) Applicant: Robert Bosch GmbH, Stuttgart (DE)

(72) Inventors: Jens Strobel, Freiberg Am Neckar (DE); Mohammad Tourian, Stuttgart (DE)

(21) Appl. No.: 18/547,158

(22) PCT Filed: Jan. 27, 2022
(86) PCT No.: PCT/EP2022/051919

§ 371 Date: Aug. 20, 2023

(30) Foreign Application Priority Data
Feb. 24, 2021 (DE) 10 2021 104 445.6

(51) Int. Cl. G01S 19/48

(52) U.S. Cl. CPC G01S 19/48

(57) ABSTRACT

A method for the GNSS-based localization of a vehicle includes (a) receiving GNSS satellite signals from at least one GNSS satellite and determining GNSS localization data using the received GNSS satellite signals, (b) receiving 5G signals and determining 5G localization data using the received 5G signals, and (c) evaluating the GNSS localization data using the 5G-localization data in order to identify possible impairments of GNSS satellite signals.

The invention relates to a method for the GNSS-based localization of a vehicle. Further specified are a computer program for performing the method, a machine-readable storage medium containing the computer program, and a localization device. The invention can in particular be used in the context of automated or autonomous driving.

### PRIOR ART

Among other things, a vehicle for autonomous operation requires sensor technology that is capable of determining a highly accurate vehicle position, in particular with the aid of navigation satellite data (e.g., GPS, GLONASS, Beidou, Galileo). For this purpose, GNSS (Global Navigation Satellite System) signals are currently received via a GNSS antenna on the vehicle roof and processed by means of a GNSS sensor. The reception of signals may be impaired, for example, by atmospheric disturbances along the signal propagation path and/or by multipath propagation due to signal reflections from objects in the vicinity of the vehicle.

Furthermore, localization sensors are known in which various mechanisms are performed to detect and, if necessary, discard erroneous GNSS measurements. Detection is typically done by running some internal statistical tests and, to date, usually without external sources. Depending on the number of available measurements, the size of the residuals, the signal strength, the velocity and the history of the measurement, pseudo distance and Doppler/delta distance outliers can be detected and the corresponding signals discarded if necessary.

### DISCLOSURE OF THE INVENTION

Proceeding from the above, GNSS-based localization, and in particular its accuracy and/or integrity, is to be improved.

Described herein according to claim 1 is a method for GNSS-based localization of a vehicle, comprising at least the following steps:
a) receiving GNSS satellite signals from at least one GNSS satellite and determining GNSS localization data using the received GNSS satellite signals,
b) receiving 5G signals and determining 5G localization data using the received 5G signals,
c) evaluating the GNSS localization data using the 5G localization data in order to identify possible impairments of GNSS satellite signals.

For example, steps a), b), and c) can be performed at least once and/or repeatedly in the sequence indicated in order to perform the method. Furthermore, steps a), b), and c), in particular steps a) and b), can be performed at least partially in parallel or simultaneously. The method can in particular be used (in a targeted manner) in urban areas, in particular in urban canyons.

In particular, the method allows 5G signals to be used as an external source for identifying erroneous GNSS measurements. The method advantageously allows error detection in GNSS signals using reference values or reference positions determined by 5G signals. In other words, this can also be described in particular as allowing 5G-based position information to be determined and used by means of the method to generate references for GNSS observations in order to detect and, if necessary, eliminate erroneous measurements. The method advantageously contributes to the verification of the integrity of GNSS measurements and can thus advantageously also contribute to the so-called Receiver Autonomous Integrity Monitoring (RAIM).

In this context, GNSS is a global navigation satellite system such as GPS (Global Positioning System) or Galileo. GNSS-based localization can also employ other GNSS-independent sensors of the vehicle, such as environmental sensors and/or inertial sensors, in order to provide alternative information for the localization of the vehicle in addition or as needed (for example, in case of GNSS shadowing). For the localization, in particular, the instantaneous (own) position, (own) orientation, (own) speed, and/or (own) acceleration of the vehicle can be determined.

The vehicle is preferably a motor vehicle, such as an automobile, which is particularly preferably set up for automated or autonomous (driving) operations. In corresponding vehicles, a plurality of environmental sensors can be used in addition to at least one GNSS receiver (for example: RADAR sensors, LIDAR sensors, camera sensors, ultrasonic sensors). For example, these environmental sensors can be used in order to detect objects around the vehicle and localize them with respect to the vehicle. Moreover, for example, environmental sensor data and/or GNSS data can be used in order to localize the vehicle on a (highly accurate) digital map. Trajectory planning and, if necessary, triggering of the vehicle actuators in order to carry out (automated or autonomous) driving operations can be carried out based on the detected objects or determined vehicle positions. In this way, the vehicle is advantageously able to navigate safely through the environment.

In step a), GNSS satellite signals are received from at least one GNSS satellite and GNSS localization data are determined using the received GNSS satellite signals. Typically, at least partially in parallel or simultaneously, GNSS satellite signals are received from a plurality of GNSS satellites. For example, respective GNSS localization data can be determined from the GNSS satellite signals by time-of-flight measurements and/or further evaluations. For example, the GNSS localization data determined in this way can include at least so-called GNSS pseudo-range data, which describe the spatial length of the signal propagation path between the respective GNSS satellite and the vehicle. However, due to impairments, such as atmospheric signal delays and/or multi-path propagation through reflections on objects in the vicinity of the vehicle, these GNSS pseudo-range data can describe signal propagation paths that are longer than the actual (shortest) distance between vehicle and satellite (at the time of sending out the respective GNSS satellite signal). This can result in erroneous GNSS measurements.

In step b), 5G signals are received and 5G localization data are determined using the received 5G signals. For example, 5G signals can be received from a plurality of 5G stations (each comprising at least one 5G transmitting device and one 5G receiving device) in the vicinity of the vehicle. The 5G signals can in particular also comprise information about the (geodetic) absolute position of the respective 5G station. Through time-of-flight of the 5G signals, the relative positions or distances between the vehicle and the respective 5G station can be determined. The determined relative positions or distances of the vehicle to a plurality of the 5G stations can in particular be combined with the information concerning the (geodetic) absolute position of the respective 5G station to, for example, a 5G-based vehicle position, for example in the manner of a triangulation.

The 5G cellular network advantageously contributes to the fact that the high requirements present in localization applications of in particular automated or autonomous vehicles can be particularly advantageously met in terms of the reliability, availability, coverage, and/or latency of the transmission types used. This helps to ensure that particularly high accuracy (as far as possible in the centimeter range) and/or particularly high integrity values can be achieved in the localization.

The new frequency allocation of 5G is particularly advantageous for cellular-based localization, because larger bandwidths at higher frequencies are available (mm wave above 24 GHz in addition to below 6 GHz). Larger bandwidths help to more accurately resolve signal time (there is an inverse relationship between time and bandwidth), so that larger bandwidths provide an improved ability to resolve multi-path effects, the main source of failures in unclear urban areas, because signals traversing different paths arrive at different times.

Switching to the new frequencies in 5G also has a particular advantageous effect on the geographic distribution of cellular base stations and antenna technologies used, which in turn favors cellular-based localization. Moreover, the introduction of 5G antenna arrays with beam-forming functions can advantageously help to direct signals in the direction of end users. A higher density of direction-detecting antennas can improve the resolution of multi-path components by measuring the delay, the arrival, and/or the exit angle and can thus improve the localization performance. Additionally, 5G allow vehicles to be localized with a single 5G station.

In step c), an evaluation of the GNSS localization data is performed using the 5G localization data to identify possible GNSS satellite signal impairments. The impairments can occur, for example, along the propagation path of a GNSS satellite signal. The impairment can be, for example, an atmospheric signal delay (e.g., in the ionosphere) and/or multipath propagation due to reflections from objects (e.g., building facades) in the vicinity of the vehicle. For example, using the 5G localization data, reference data for the GNSS localization data can be determined. For example, the reference data may include reference position data and/or reference distance data, such as reference pseudo-range data.

As an example, reference data for GNSS observations can be generated using the 5G localization data to enable detection and, if necessary, elimination of erroneous measurements. Since 5G is less sensitive to multipath effects, the method described is particularly advantageous for providing the most robust detection of multipath contaminated GNSS measurements. The method can be used to particular advantage in urban canyons, since on the one hand GNSS signals are more at risk of being affected than 5G signals, and on the other hand the 5G-based position is advantageously more reliable, especially if a dense 5G network is available.

According to an advantageous embodiment, it is proposed that the GNSS localization data comprises at least GNSS pseudo-range data. The GNSS pseudo-range data can be obtained from GNSS time-of-flight measurements. The GNSS pseudo-range data usually describe the spatial length of the signal propagation path between the respective GNSS satellite (emitting the signal in question) and the vehicle.

According to a further advantageous embodiment, it is proposed that in step b) at least one 5G-based vehicle position is determined using the 5G signals. For example, time-of-flight measurements of one or more 5G signals can be performed to determine the 5G-based vehicle position. The relative position information to one or more 5G stations obtained in this way can be combined with absolute position information to the relevant 5G station(s) to form a spatial vehicle position. In particular, (only) those 5G signals are used which match the GNSS satellite signals received in step a) for example on the basis of their time stamp or time. In particular, it can be provided that information and/or signals from only one or a single 5G station in the vicinity of the vehicle are used to determine a 5G-based vehicle position. For example, one or more direction-sensing 5G antennas (of the vehicle and/or the 5G station) can contribute to this. Furthermore, at least one measurement of the delay, angle of arrival, and/or angle of departure of the 5G signal can contribute to this.

According to a further advantageous embodiment, it is proposed that in step b) distance data describing the distance between the vehicle and the at least one satellite is determined using the 5G-based vehicle position. For this purpose, for example, catalogued information on satellite orbits or satellite positions, for example ephemeris data, can be used. From the corresponding information as well as the 5G-based vehicle position, a spatial (shortest) distance between the vehicle and the at least one satellite can be calculated. In this context, it can also be provided that the distance (value) determined in this way is corrected with known influences on the determination of the GNSS pseudo-range data or is supplemented by these influences. For example, a 5G pseudo-range data can be obtained that can be compared as easily or well as possible with the GNSS pseudo-range data.

According to a further advantageous embodiment, it is proposed that in step c) the distance data (obtained using the 5G-based vehicle position) is compared with GNSS pseudo-range data. In particular, (only) data with essentially matching timestamps are used for the comparison. For example, a possible difference between the distance data and the GNSS pseudo-range data can be determined. In particular, pseudo-range residuals can be determined from an existing difference of (5G pseudo) distance data and associated GNSS pseudo-range data, which can be advantageously used to detect mismeasurements by statistical tests.

According to a further advantageous embodiment, it is proposed that in step c) an impairment is identified when a significant discrepancy between distance data and associated pseudo-range data are determined. For example, deviations of more than 10% or more than 20% could be considered “significant”. Identification is particularly concerned with identifying the presence of an impairment and usually less concerned with the nature of the impairment. However, (additional) statistical evaluations can be performed to infer the type of impairment. For example, determined pseudo-range residuals can be identified as multipath propagation suspects based on statistical tests.

According to a further advantageous embodiment, it is proposed that information obtained with GNSS satellite signals and/or GNSS satellites to which an impairment has been identified is weighted or excluded from GNSS-based localization for further processing purposes. In particular, GNSS measurements identified as erroneous can be excluded from GNSS-based localization. Alternatively or additionally, a reduced or degraded integrity value may be assigned to the GNSS satellite signals and/or GNSS satellites to which an impairment has been identified. Furthermore, a reduced or degraded integrity value can be assigned to a vehicle position determined using GNSS satellite signals and/or GNSS satellites to which a (momentary) impairment has been identified. In addition, GNSS satellite signals and/or GNSS satellites to which an (instantaneous) impairment has been identified can be placed under observation, in particular for a predeterminable period of time. For example, these may be less trusted than other GNSS satellite signals or GNSS satellites, particularly during the time period.

Proposed according to a further aspect is a computer program for performing a method proposed here. In other words, this aspect relates in particular to a computer program (product) comprising instructions which, when the program is executed by a computer, prompt the latter to perform a method described here.

Proposed according to a further aspect is a machine-readable storage medium on which the computer program proposed here is stored or saved. Conventionally, the machine-readable storage medium is a computer-readable disk.

Proposed according to a further aspect is a localization device for a vehicle, wherein the localization device is configured so as to perform a method described here. The localization device can, for example, comprise a computer and/or control unit (controller) able to execute instructions for performing the method. The computer or control unit can, e.g., execute the computer program specified for this purpose. For example, the computer or control unit is able to access the specified storage medium in order to execute the computer program. For example, the localization device can be a movement and position sensor, in particular arranged in or on the vehicle.

The details, features, and advantageous configurations explained in connection with the method can also be correspondingly performed by the computer program, and/or the storage medium, and/or in the localization device presented here, and vice versa. In this respect, reference is made to the entirety of said explanations for a more specific characterization of the features.

The solution presented here and the technical environment thereof are explained in greater detail hereinafter with reference to the drawings. It should be noted that the invention is not intended to be limited by the embodiment examples disclosed. In particular, unless explicitly shown otherwise, it is also possible to extract partial aspects of the facts explained in the figures and to combine them with other components and/or findings from other figures and/or the present description. The following is shown schematically:

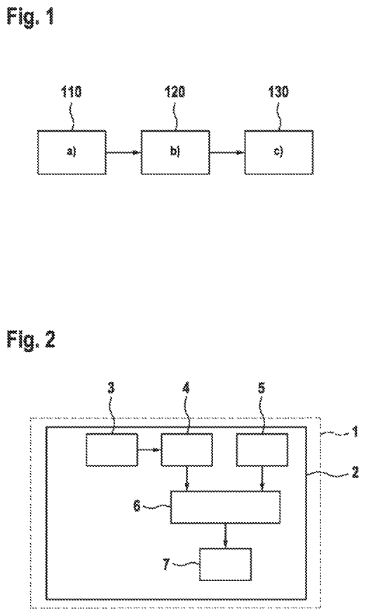

FIG. 1: An exemplary workflow of the method presented herein, and

FIG. 2: An exemplary structure of the localization device presented here.

FIG. 1 schematically shows an exemplary sequence of the method presented here. The method is used for GNSS-based localization of a vehicle 1 (cf. FIG. 2). The sequence of steps a), b) and c) shown with blocks 110, 120 and 130 is an example and can, for example, be carried out at least once in the shown sequence to carry out the method. The steps a), b) and c), in particular steps a) and b), can furthermore also be carried out at least partially in parallel or simultaneously.

In block 110, according to step a), receiving GNSS satellite signals from at least one GNSS satellite and determining GNSS localization data using the received GNSS satellite signals. Here, the GNSS localization data may include at least GNSS pseudo-range data.

In block 120, according to step b), 5G signals are received and 5G localization data are determined using the received 5G signals. In step b), for example, at least one 5G-based vehicle position can be determined using the 5G signals. Furthermore, using the 5G-based vehicle position, distance data describing the distance between the vehicle and the at least one satellite can be determined.

In block 130, according to step c), an evaluation of the GNSS localization data is performed using the 5G localization data to identify possible GNSS satellite signal impairments. For example, in step c), the distance data obtained using the 5G-based vehicle position can be compared with GNSS pseudo-range data. Specifically, impairment can be identified when a significant discrepancy between distance data and associated pseudo-range data is identified. In particular, pseudo-range residuals can be determined from the difference of (pseudo) distance data and associated pseudo-range data, which can be advantageously used to detect mismeasurements by statistical tests.

Thus, exemplary reference data for GNSS observations can be generated using 5G-based positions to enable detection and, if necessary, elimination of erroneous measurements. Since 5G is less sensitive to multipath effects, the method described is particularly advantageous for providing the most robust detection of multipath contaminated GNSS measurements. The method can be used to particular advantage in urban canyons, where GNSS signals are at greater risk of being impaired than 5G signals, and on the other hand 5G-based positioning is advantageously more reliable, especially when a dense 5G network is available.

In addition, information obtained with GNSS satellite signals and/or GNSS satellites to which an impairment has been identified may be weighted or excluded from GNSS-based localization for further processing purposes. Thus, the method can advantageously contribute to a so-called Receiver Autonomous Integrity Monitoring (RAIM).

FIG. 2 schematically shows an exemplary structure of the localization device 2 presented here for a vehicle 1. The localization device 2 is configured so as to perform a method described here.

For this purpose, the localization device 2 may exemplarily comprise a GNSS module 2, a time update module 4, a 5G module 5, an error detection module 6, and a measurement update module 7. The GNSS module 2 is exemplarily provided and configured so as to receive GNSS satellite signals from at least one GNSS satellite and determine GNSS localization data using the received GNSS satellite signals. The 5G module 5 is exemplarily provided and configured so as to receive 5G signals and determine 5G localization data using the received 5G signals. The error detection module 6 is exemplarily provided and configured so as to evaluate the GNSS localization data using the 5G localization data to identify possible impairments of GNSS satellite signals. The time update module 4 and the measurement update module 7 can contribute to the most efficient data handling in the localization device 2. However, they can in principle also be omitted or replaced by comparable modules.

In particular, the method allows 5G signals to be used particularly advantageously as an external source for identifying erroneous GNSS measurements. Thus, the method contributes in an advantageous way to improving the GNSS-based localization, in particular to performing it as accurately as possible.

1. A method for GNSS-based localization of a vehicle, comprising:
a) receiving GNSS satellite signals from at least one GNSS satellite and determining GNSS localization data using the received GNSS satellite signals,
b) receiving 5G signals and determining 5G localization data using the received 5G signals, and
c) evaluating GNSS localization data using the 5G localization data to identify possible GNSS satellite signal impairments.

2. The method according to claim 1, wherein the GNSS localization data comprises at least GNSS pseudo-range data.

3. The method according to claim 1, wherein step b) includes determining at least one 5G-based vehicle position using the 5G signals.

4. The method according to claim 3, wherein step b) includes using the 5G-based vehicle position, to determine distance data describing the distance between the vehicle and the at least one satellite.

5. The method according to claim 4, wherein step c) includes comparing the distance data to GNSS pseudo-range data.

6. The method according to claim 5, wherein in step c) includes identifying an impairment when a significant discrepancy between distance data and associated pseudo-range data are identified.

7. The method according to claim 1, wherein information obtained with GNSS satellite signals and/or GNSS satellites to which an impairment has been identified is weighted or excluded from the GNSS-based localization for further processing purposes.

8. A computer program for performing a method according to claim 1.

9. A machine-readable storage medium on which the computer program according to claim 8 is stored.

10. A localization device for a vehicle configured so as to carry out a method according to claim 1.
